(19) United States
(12) Patent Application Publication
(10) Pub. No.: US 2021/0176416 A1
(43) Pub. Date: Jun. 10, 2021

(54) CAMERA INFORMATION AND POWER OVER ETHERNET CONTROL FROM VIDEO MANAGEMENT SYSTEM

(71) Applicant: Carrier Corporation, Palm Beach Gardens, FL (US)

(72) Inventor: Steven MITCHELL, Villa Park, CA (US)

(21) Appl. No.: 17/255,477

(22) PCT Filed: Aug. 28, 2019
(86) PCT No.: PCT/US2019/048482

§ 371 Date: Dec. 23, 2020

Related U.S. Application Data
(60) Provisional application No. 62/726,560, filed on Sep. 4, 2018.

(51) Int. Cl. H04N 5/369; H04N 7/18; H04N 5/232

(52) U.S. Cl. CPC H04N 5/3698; H04N 5/232061; H04N 7/181

(57) ABSTRACT

A method of operating a camera system comprising one or more cameras. The method including: detecting a camera being connected to a network switch; obtaining a model number of the camera, a MAC address of the camera, and an IP address of the camera; obtaining at least one of a name of the camera and a location of the camera; and assigning the model number of the camera, the MAC address of the camera, and the IP address of the camera to at least one of the name and the location of the camera.

### BACKGROUND

The subject matter disclosed herein relates generally to a video management system, and specifically to a method and apparatus for identification of cameras within a video management system.

Commonly, Industrial Fast Ethernet Switch (IFS) network switches do not have the ability to report what camera or recorder is connected to which port on the IFS network switch. If any service needs to done to a camera it is difficult to know which camera is plugged into to what port or even which IFS switch it is plugged into. If a camera needs to be re-booted, one will need to figure out what port and which camera to re-boot, which is often a difficult and time consuming task.

### BRIEF SUMMARY

According to an embodiment, a method of operating a camera system comprising one or more cameras is provided. The method including: detecting a camera being connected to a network switch; obtaining a model number of the camera, a MAC address of the camera, and an IP address of the camera; obtaining at least one of a name of the camera and a location of the camera; and assigning the model number of the camera, the MAC address of the camera, and the IP address of the camera to at least one of the name and the location of the camera.

In addition to one or more of the features described herein, or as an alternative, further embodiments may include that the network switch is an Industrial Fast Ethernet Switch (IFS) network switch.

In addition to one or more of the features described herein, or as an alternative, further embodiments may include that the camera is an open network video interface forum (ONVIF) device.

In addition to one or more of the features described herein, or as an alternative, further embodiments may include that the at least one of a name of the camera and a location of the camera is obtained through a manual input by a user of a computing device.

In addition to one or more of the features described herein, or as an alternative, further embodiments may include: generating a graphical illustration of the network switch on a computing device, the graphical illustration depicting one or more ports of the network switch.

In addition to one or more of the features described herein, or as an alternative, further embodiments may include that one of the one or more ports of the network switch identifies at least one of a name of the camera and a location of the camera.

In addition to one or more of the features described herein, or as an alternative, further embodiments may include that the graphical illustration displays an activity level of each of the one or more ports of the network switch.

In addition to one or more of the features described herein, or as an alternative, further embodiments may include that the activity level indicates whether each of the one or more ports is active, inactive, or active with power over Ethernet.

In addition to one or more of the features described herein, or as an alternative, further embodiments may include: generating a graphical illustration of a bandwidth of the camera on a computing device.

According to another embodiment, a camera system is provided. The camera system including: a processor; and a memory comprising computer-executable instructions that, when executed by the processor, cause the processor to perform operations, the operations including: detecting a camera being connected to a network switch; obtaining a model number of the camera, a MAC address of the camera, and an IP address of the camera; obtaining at least one of a name of the camera and a location of the camera; and assigning the model number of the camera, the MAC address of the camera, and the IP address of the camera to at least one of the name and the location of the camera.

In addition to one or more of the features described herein, or as an alternative, further embodiments may include that the network switch is an Industrial Fast Ethernet Switch (IFS) network switch.

In addition to one or more of the features described herein, or as an alternative, further embodiments may include that the camera is an open network video interface forum (ONVIF) device.

In addition to one or more of the features described herein, or as an alternative, further embodiments may include that the at least one of a name of the camera and a location of the camera is obtained through a manual input by a user of a computing device.

In addition to one or more of the features described herein, or as an alternative, further embodiments may include that the operations further include: generating a graphical illustration of the network switch on a computing device, the graphical illustration depicting one or more ports of the network switch.

In addition to one or more of the features described herein, or as an alternative, further embodiments may include that one of the one or more ports of the network switch identifies at least one of a name of the camera and a location of the camera.

In addition to one or more of the features described herein, or as an alternative, further embodiments may include that the graphical illustration displays an activity level of each of the one or more ports of the network switch.

In addition to one or more of the features described herein, or as an alternative, further embodiments may include that the activity level indicates whether each of the one or more ports is active, inactive, or active with power over Ethernet.

In addition to one or more of the features described herein, or as an alternative, further embodiments may include that the operations further include: generating a graphical illustration of a bandwidth of the camera on a computing device.

According to another embodiment, a computer program product tangibly embodied on a computer readable medium is provided. The computer program product including instructions that, when executed by a processor, cause the processor to perform operations comprising: detecting a camera being connected to a network switch; obtaining a model number of the camera, a MAC address of the camera, and an IP address of the camera; obtaining at least one of a name of the camera and a location of the camera; and assigning the model number of the camera, the MAC address of the camera, and the IP address of the camera to at least one of the name and the location of the camera.

Technical effects of embodiments of the present disclosure include a video management system configured to distinguish between different cameras connected to a switch and maintain a physical location of each camera.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 illustrates a schematic view of a camera system, in accordance with an embodiment of the disclosure;

FIG. 2 illustrates a graphical user interface of a video management system of the camera system of FIG. 1, in accordance with an embodiment of the disclosure; and

FIG. 3 is a flow chart of method of operating a camera system, in accordance with an embodiment of the disclosure.

### DETAILED DESCRIPTION

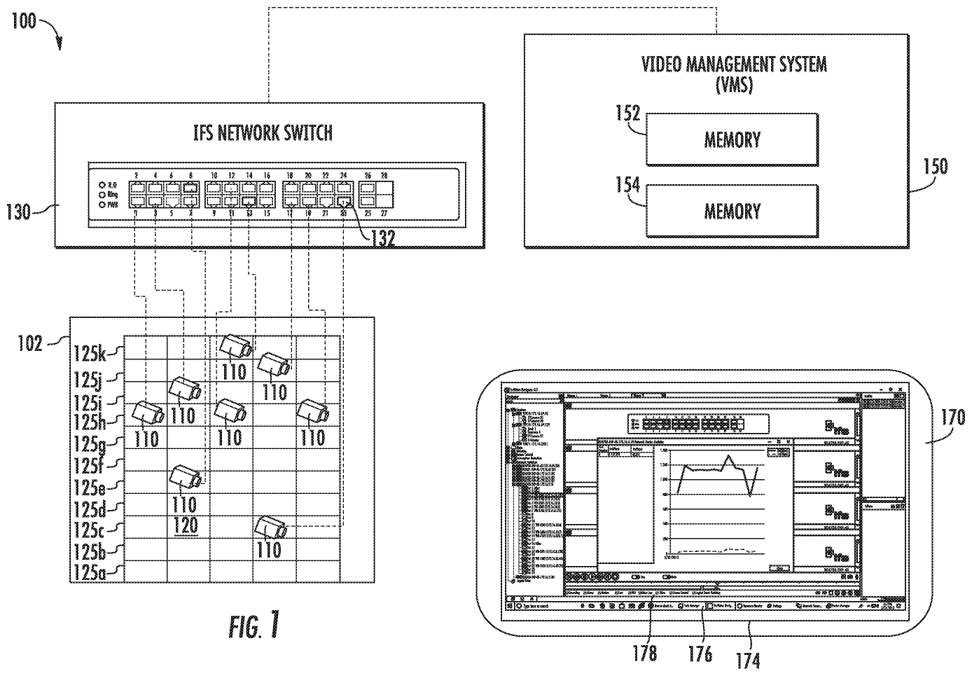

FIG. 1 is a schematic view of a camera system 100, according to an embodiment of the present disclosure. In an embodiment, the camera system 100 is a video camera system. It should be appreciated that, although particular systems are separately defined in the schematic block diagrams, each or any of the systems may be otherwise combined or separated via hardware and/or software. The camera system 100 is organized within a building 102 having a plurality of floors 125a-125k but it is understood that embodiment disclosure herein may be applicable to camera systems 100 located partially or fully outside of a building 102. It is also understood that while eleven landings 125a-125k are utilized for exemplary illustration, embodiments disclosed herein may be applied to buildings 102 having any number of landings.

The camera system 100 may include one or more cameras 110. In an example, the cameras 110 may be a Truvision camera or an ONVIF compliant camera. Each of the cameras 110 may be located in one or more rooms 120 of the building 102 on one or more different floors 125a-125k. There may also be multiple cameras 110 per room 120. The one or more cameras 110 are each hardwired to an Industrial Fast Ethernet Switch (IFS) network switch 130. The IFS network switch 130 may include one or more ports 132 for each of the cameras 110 to connect to using an Ethernet cable. A single camera 110 may connect to a single port 132 on the IFS network switch 130. Some ports 132 on the IFS network switch 130 may also be utilized to connect the IFS network switch 130 to other IFS network switch 130 in a daisy chain of IFS network switches 130.

The camera system 100 also includes a video management system (VMS) 150 in communication with the IFS network switch 130 through a hardwired or wireless connection. The VMS 150 may be located local to the building 102, remote from the building 120, or may be cloud based. The VMS 150 may be an electronic controller including a processor 154 and an associated memory 152 comprising computer-executable instructions that, when executed by the processor 154, cause the processor 154 to perform various operations. The processor 154 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 152 may be but is not limited to a random access memory (RAM), read only memory (ROM), or other electronic, optical, magnetic or any other computer readable medium.

The VMS 150 may be accessible through software, an internet web page, or an application via a user interface 178 on a computing device 170. The computing device 170 may be a desktop computer, laptop computer, smart phone, tablet computer, smart watch, or any other computing device known to one of skill in the art. In the example shown in FIG. 1, the computing device 170 is a tablet computer. The computing device 170 may include a display screen 174 and an input device 176, such as, example, a mouse, a touch screen, a scroll wheel, a scroll ball, a stylus pen, a microphone, a camera, etc. In the example shown in FIG. 1, since the computing device 170 is a tablet computer, then the display screen 174 may also function as an input device 176.

An installer of the camera system 100 may carry or have access to a computing device 170 during the installation of the camera system 100. The VMS 150 is able to detect when a camera 110 is plugged into a port 132 of the IFS network switch 130 and the VMS 150 obtains the model number of the camera 110, the MAC address of the camera 110, and IP address of the camera 110. For example, if the network switch 130 is added to the VMS 150 after the cameras 110 have been added then the VMS 150 may be able to detect when a camera 110 is plugged into a port 132 of the IFS network switch 130 and obtains the model number of the camera 110, the MAC address of the camera 110, and IP address of the camera 110. However, if the network switch 130 is added to the VMS 150 before the cameras 110 have been added then a refresh of the network switch 130 may need to be done before the VMS 150 is able to detect when a camera 110 is plugged into a port 132 of the IFS network switch 130 and obtains the model number of the camera 110, the MAC address of the camera 110, and IP address of the camera 110. In an embodiment, the camera is an Open Network Video Interface Forum (ONVIF). The VMS 150 is configured to display on the computing device 170 the model number of the camera 110, the MAC address of the camera 110, and IP address of the camera 110. The installer can enter in a location and/or identification name for camera 110 through an input on the computing device 170. The location and identification name for the camera 110 is then stored in the VMS 150.

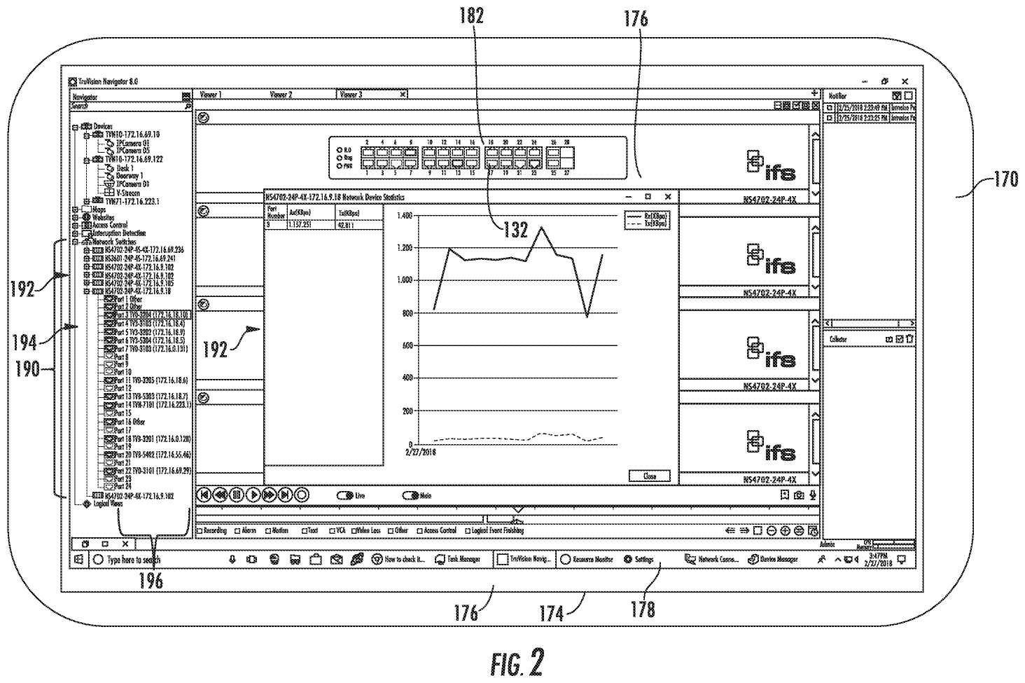

Referring now to FIG. 2 with continued reference to FIG. 1, which illustrates a graphical user interface 178 of VMS 150 on the computing device 170. A user (e.g., an installer) may interact with the VMS 150 through the graphical user interface 178 by a “click”, “touch”, verbal command or any other input to the user interphase 178. The user may be able to view the entire camera system 100 through a graphical tree 190. The graphical tree 190 displays all the IFS network switches 130 of the camera system at 192. The user could select a specific IFS network switch 130 of the camera system at 192 and view the ports 132 of the IFS Network Switch 130 at 194. The graphical tree 190 will also display the identification name and location of each camera 110 and each port 132 at 196.

The user may be able to view a graphical illustration 182 of the IFS Network Switch 130 through the graphical user interface 178 of the VMS 150. The graphical illustration 182 of the IFS network switch 130 will display each port 132 of the IFS network switch 130 and whether the activity level of the port 132, such as for example whether, a camera 110 is connected to the port 132. For example, the graphical illustration 182 of the IFS network switch 130 may display an activity level of each port 132 indicating whether each port 132 is active, inactive or active with power over Ethernet (PoE). A user may also be able to cycle the power of each camera 110 through the graphical user interphase 178 of the VMS 150 and/or check the current bandwidth 186. The graphical user interphase 178 is configured to display a graphical illustration of the bandwidth 186 from an individual port 132 on the computing device 170, as shown in FIG. 2.

Advantageously, a user utilizing a computing device 170 will be able to identify an identification name and location of a camera 60 to quickly troubleshoot problems with the camera 60.

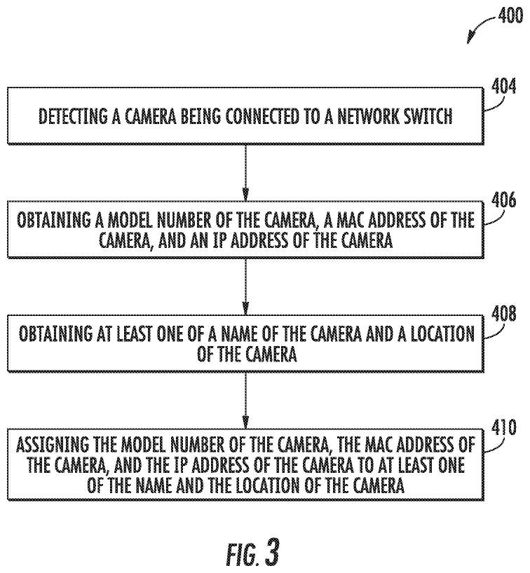

Referring now to FIG. 3, with continued reference FIGS. 1-2. FIG. 3 shows a flow chart of method 400 of operating camera system 100 comprising one or more cameras 110, in accordance with an embodiment of the disclosure. In an embodiment, the method 400 may be performed by the video management system 150. At block 404, a camera 110 being connected to a network switch is detected. In an embodiment the network switch is an IFS network switch 130. In an embodiment, the camera 110 is an ONVIF device. At block 406, a model number of the camera 110, a MAC address of the camera 110, and an IP address of the camera 110 is obtained. The model number of the camera 110, the MAC address of the camera 110, and the IP address of the camera 110 may be obtained automatically by the VMS 150 communicating with the camera 110 or through a manual input by a user of a computing device 170.

At block 408, at least one of a name of the camera 110 and a location of the camera 110 is obtained. In an embodiment, the at least one of a name of the camera 110 and a location of the camera 110 may be obtained through a manual input by a user of a computing device 170. In an embodiment, the location is obtained manually from the user and added to the name of the camera 110. At block 410, the model number of the camera 110, the MAC address of the camera 110, and the IP address of the camera 110 is assigned to at least one of the name and the location of the camera 110. The assignment may be made in the memory 152 of the VMS 150, so that the camera 110 may be identified.

The method 400 may further comprise: generating a graphical illustration 182 of the network switch 130 on a computing device 170. The graphical illustration 182 depicting one or more ports 132 of the network switch 130. One of the one or more ports 130 of the network switch 130 identifies at least one of a name of the camera 110 and a location of the camera 110. As described above, the graphical illustration 182 may also display an activity level of each of the one or more ports 132 of the network switch 130 such as, for example, whether each of the one or more ports 132 is active, inactive, or active with power over Ethernet. The method 400 may also comprise: generating a graphical illustration of a bandwidth of the camera 110 on a computing device 170, as shown at 192.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of operating a camera system comprising one or more cameras, the method comprising:
detecting a camera being connected to a network switch;
obtaining a model number of the camera, a MAC address of the camera, and an IP address of the camera;
obtaining at least one of a name of the camera and a location of the camera; and
assigning the model number of the camera, the MAC address of the camera, and the IP address of the camera to at least one of the name and the location of the camera.

2. The method of claim 1, wherein the network switch is an Industrial Fast Ethernet Switch (IFS) network switch.

3. The method of claim 1, wherein the camera is an open network video interface forum (ONVIF) device.

4. The method of claim 1, wherein the at least one of a name of the camera and a location of the camera is obtained through a manual input by a user of a computing device.

5. The method of claim 1, further comprising:
generating a graphical illustration of the network switch on a computing device, the graphical illustration depicting one or more ports of the network switch.

6. The method of claim 5, wherein one of the one or more ports of the network switch identifies at least one of a name of the camera and a location of the camera.

7. The method of claim 5, wherein the graphical illustration displays an activity level of each of the one or more ports of the network switch.

8. The method of claim 7, wherein the activity level indicates whether each of the one or more ports is active, inactive, or active with power over Ethernet.

9. The method of claim 1, further comprising:
generating a graphical illustration of a bandwidth of the camera on a computing device.

10. A camera system comprising:
a processor; and
a memory comprising computer-executable instructions that, when executed by the processor, cause the processor to perform operations, the operations comprising:
detecting a camera being connected to a network switch;
obtaining a model number of the camera, a MAC address of the camera, and an IP address of the camera;
obtaining at least one of a name of the camera and a location of the camera; and
assigning the model number of the camera, the MAC address of the camera, and the IP address of the camera to at least one of the name and the location of the camera.

11. The camera system of claim 1, wherein the network switch is an Industrial Fast Ethernet Switch (IFS) network switch.

12. The camera system of claim 1, wherein the camera is an open network video interface forum (ONVIF) device.

13. The camera system of claim 1, wherein the at least one of a name of the camera and a location of the camera is obtained through a manual input by a user of a computing device.

14. The camera system of claim 1, wherein the operations further comprise:
generating a graphical illustration of the network switch on a computing device, the graphical illustration depicting one or more ports of the network switch.

15. The camera system of claim 14, wherein one of the one or more ports of the network switch identifies at least one of a name of the camera and a location of the camera.

16. The camera system of claim 14, wherein the graphical illustration displays an activity level of each of the one or more ports of the network switch.

17. The camera system of claim 16, wherein the activity level indicates whether each of the one or more ports is active, inactive, or active with power over Ethernet.

18. The camera system of claim 1, wherein the operations further comprise:
generating a graphical illustration of a bandwidth of the camera on a computing device.

19. A computer program product tangibly embodied on a computer readable medium, the computer program product including instructions that, when executed by a processor, cause the processor to perform operations comprising:
detecting a camera being connected to a network switch;
obtaining a model number of the camera, a MAC address of the camera, and an IP address of the camera;
obtaining at least one of a name of the camera and a location of the camera; and
assigning the model number of the camera, the MAC address of the camera, and the IP address of the camera to at least one of the name and the location of the camera.
